(19) United States
(12) Patent Application Publication
(10) Pub. No.: US 2024/0143856 A1
(43) Pub. Date: May 2, 2024

(54) SYSTEM FOR MONITORING BUILDING PROCESSES

(71) Applicant: Denis Olegovich KUZNETSOV, Moscow (RU)

(72) Inventor: Denis Olegovich KUZNETSOV, Moscow (RU)

(21) Appl. No.: 18/281,002

(22) PCT Filed: May 4, 2021
(86) PCT No.: PCT/RU2021/000187

§ 371 Date: Sep. 21, 2023

(30) Foreign Application Priority Data
Mar. 11, 2021 (RU) 2021106327

(51) Int. Cl. G06F 30/13; G06T 19/00

(52) U.S. Cl. CPC G06F 30/13; G06T 19/00; G06T 2219/004

(57) ABSTRACT

A system for controlling construction processes is proposed, which comprises: a remote server, and a computing device connected with video cameras, a memory module, a data exchange module and a display module. The server stores a three-dimensional information model of a structure and data containing information about the structure elements. The computing device is configured to: receive the information model and the data; recognize the markers upon scanning and calculate distances to them; download the information about the elements and their identification codes; and, when scanning the markers and if data about the association of the markers with the identification codes and the data from the server are available, download the information about the elements, determine the mutual position between the recognized markers, issue commands to the display module to display the downloaded information and the results of comparison, and store corresponding data and transmit them to the server.

### FIELD OF INVENTION

The invention relates to the field of construction and assembly of structures, namely to a system for controlling the processes of constructing and assembling structures using the BIM technology. The invention is applicable for the construction and assembly of buildings, bridges, ships, airplanes, furniture, and other objects.

### BACKGROUND

The BIM technology (Building Information Model or Modeling—information modeling of buildings and structures) covers the processes of design, construction, and operation of various structures using a single coordinated system of three-dimensional models. The main BIM element is the information that is included in a project, as well as the exchange process of this information between various participants.

Hereinafter, the use of the BIM technology implies the availability of an information model of a structure and the ability to work with the three-dimensional model of the structure.

A system for controlling construction processes is known from the prior art (CN 110335341 A, Oct. 15, 2019). The known system comprises a remote server and at least one computing device connected with a memory module, a data exchange module for communication with the remote server, a display module, and an interface module. The remote server is configured to store an information model of a structure, in which information about its elements is recorded. The computing device is configured to receive, from the remote server, the information model via the data exchange module, store it in the memory module, and issue a command to the display module to display the three-dimensional model of the structure and the information about its elements. The interface module allows a user to enter a label of a structure defect detectable during inspection on the corresponding section of the three-dimensional model. The computing device stores the changes in the memory module and sends the corrected three-dimensional model to the remote server via the data exchange module.

In this way, the construction process is controlled. This method does not allow one to detect defects in automatic mode.

KR 101897434 B1 (Sep. 10, 2018) discloses a system for controlling construction processes, which comprises at least one computing device connected with one or more video cameras for scanning markers, a memory module, a data exchange module, and a display module. The computing device is configured to: obtain an information model by means of the data exchange module and store it in the memory module; recognize the markers applied in the form of barcodes or QR codes on elements of a structure; when scanning them with a video camera, download information about the corresponding elements; generate a two-dimensional model of the scanned part of the structure; select the corresponding two-dimensional part of the structure from the information model; and compare these parts. After the comparison, the display module di splays the discrepancies—this is how construction control is performed.

The main disadvantages of this solution are the impossibility of remote control over construction or assembly processes and the low information content of the model.

U.S. Ser. No. 10/739,590 B2 (Aug. 11, 2020) discloses a system for controlling construction processes, which comprises a remote server and at least one computing device connected with one or more video cameras for scanning markers, a memory module, a data exchange module for communication with the remote server, and a display module. The remote server is configured to store an information model of a structure and data containing information about elements of the structure and location coordinates on them for the application of the markers. The computing device is configured to receive, from the remote server, the information model and the data by means of the data exchange module and store them in the memory module, recognize the markers when performing said scanning after the markers are applied to the elements of the structure in accordance with the marked locations in the information model. Also, the computing device downloads, when recognizing the markers applied on the elements of the structure, the information model and the data for displaying the model by means of the display module in an augmented reality mode. The markers serve as reference points for determining the position of an operator, and the operator can compare the location of the markers in the model with the current one in real time.

The disadvantages of the above solution are the lack of the automated comparison of the model of the structure with the current location of its elements, the lack of the accuracy of matching the markers when scanning them, as well as the lack of the possibility to remotely control the correctness of the structure assembly.

### SUMMARY

The task of the invention is to create a solution integrated with the BIM technology, which makes it possible to control the construction and assembly of structures from the moment of production to assembly from anywhere in the world, to compare the position of structure elements with a design position clearly and automatically.

The technical result is to reduce the time required to construct and assemble structures due to the capabilities of a computing device.

The above technical result is achieved by a system for controlling construction processes, comprising a remote server and at least one computing device connected with one or more video cameras for scanning markers, a memory module, a data exchange module for communication with the remote server, and a display module.

In this case, the remote server is configured to store a three-dimensional information model of a structure and data containing information about elements of the structure, coordinates of design places on them for applying the markers, and identification codes of the elements making it possible to reveal information about them, and also configured to store transmitted data.

The computing device is configured to receive, from the remote server, the information model and the data by means of the data exchange module and store them in the memory module, while scanning the markers for their recognition and calculating distances to the recognized markers, as well as configured to:
download the information about the elements of the structure and their identification codes after receiving the data from the remote server, associate the identification codes of the elements with the recognized markers before or after applying them to the elements in accordance with the coordinates of the design places, issue a command to the display module to display the downloaded information about the elements whose identification codes are associated with the markers, store data about said association in the memory module, and transmit them to the remote server via the data exchange module;
when scanning the markers and if the data about said association of the markers with the identification codes and the data from the remote server are available, the computing device downloads the information about the elements of the structure, on which the markers are recognized, with the coordinates of the design places for them on the elements, determines a mutual position between the recognized markers, compares them with a mutual position of the markers according to the coordinates of the design places, and issues a command to the display module to display the downloaded information, the results of the comparison, as well as the distances to the markers and/or distances between the markers, stores data about the recognized markers and the distances to them, as well as about the results of the comparison in the memory module and transmits them to the remote server through the data exchange module.

In a particular embodiment, the computing device may, when scanning one or more of the markers and if the data about said association of the markers with the identification codes and the data from the remote server are available, download the information about the elements of the structure on which the markers are recognized, and create the three-dimensional model reflecting the current location of the elements of the structure with the recognized markers, issue commands to the display module to display the downloaded information about the elements and the created three-dimensional model, store it in the memory module, and transmit it to the remote server via the data exchange module.

Preferably, the computing device may, when scanning one or more of the markers and if the data about said association of the markers with the identification codes and the data from the remote server are available, download the information about the elements of the structure on which the markers are recognized, issue commands to the display module to display the distances to the markers and the downloaded information, store the data about said recognition of one or more of the markers and the distances to them in the memory module, and transmit them to the remote server via the data exchange module.

Also, the computing device, when scanning one or more markers and having data about their association with identification codes and storing the three-dimensional design information model in the memory module, may issue commands to the display module to display at least a portion of the three-dimensional design model showing the elements on which the markers are recognized.

More specifically, the computing device may, when scanning one or more of the markers and if the data about said association of the markers with the identification codes and said storing the three-dimensional information model of the structure in the memory module are available, issue commands to the display module to display at least a portion of the three-dimensional model of the structure that shows the elements on which the markers are recognized in an augmented reality mode.

Additionally, the system comprises a GPS module connected with the computing device, which is configured, when scanning one or more of the markers and if the data about said association of the markers with the identification codes are available, to calculate the distances to the recognized markers, assign GPS coordinates to the recognized markers, store the corresponding data in the memory module, and transmit them to the remote server via the data exchange module.

If the results of said recognition of the markers and the calculated distances to them after a first scan are stored in the memory module, the computing device may issue a command to the display module to display the distances to locations of unrecognized or hidden markers if the markers are partly recognized on a next scan.

At least one video camera may be provided in a smartphone, a tablet computer, a laptop computer, a surveillance system, virtual reality glasses, augmented reality glasses, on a worker's helmet, and/or on a quadcopter.

By using the data containing the information about the elements of structure with the coordinates of the design places on the elements for the markers, it is possible to determine design distances and angular positions between the markers placed on these places and the elements in the assembled condition, respectively. The possibility to calculate the distances to the markers and, respectively, to the elements of the structure when recognizing the markers allows one to compare the design position of the elements marked in the information model with the actual location with an acceptable error. By displaying the information on compliance or rejection, as well as by recording and transmitting such information to the remote server for remote monitoring, it is possible to substantially reduce the time required to find and correct violations, thereby reducing construction and assembly terms.

### BRIEF DESCRIPTION OF THE DRAWINGS

The present invention is explained with reference to drawings.

FIGS. 1A-1B show an exemplary image of a three-dimensional information model of a structure with labeled locations for applying markers according to data.

FIGS. 2A-2B show examples of how a display module may, when scanning the markers, display information about the elements on which the markers are recognized, and the results of comparing the current mutual position of the markers with the mutual position according to the coordinates of design places, as well as according to the display of distances to the markers and between them.

FIGS. 3A-3C show examples of how the display module may, when scanning the markers, display the distances to the markers and the information about the elements on which the markers are recognized, and the locations of unrecognized or hidden markers when re-scanning the markers.

FIGS. 4A-4B show an example of how the computing device may, when scanning the markers, generate the three-dimensional model showing the location of the elements of the structure relative to each other.

FIGS. 5A-5B are photographs showing examples of how the display module may, when scanning the markers, display at least a portion of the three-dimensional model of the structure that shows the elements on which the markers are recognized.

### DETAILED DESCRIPTION OF THE PREFERRED EMBODIMENT

The system according to the present invention may be applied to buildings, bridges, ships, airplanes, furniture, and other structures of various sizes and purposes.

The proposed system for controlling the processes of constructing and assembling structures using the BIM technology includes a remote server and at least one computing device connected with one or more video cameras for scanning markers, a memory module, a data exchange module for communication with the remote server, and a display module. The operational principle of the system and the methods of its implementation will be obvious to a person skilled in the art based on the description given below.

The video camera, the memory module, the data exchange module, and the display module may be combined with the computing device which is typically a smartphone, a laptop computer, or a tablet computer. The combination of two or more devices is possible, for example, a laptop and an external camera, such as an IP camera, or a camera mounted on a worker's helmet or quadcopter.

Accordingly, the video camera may be installed in a smartphone, a tablet computer, a laptop, a surveillance system, virtual reality glasses, augmented reality glasses, on a worker's helmet, or on a quadcopter. The computing device necessarily comprises a processor that executes a program code. The memory module is a built-in or external data storage device, the data exchange module is also a built-in or external modem in the computing device that performs mostly wireless communication with the remote server, and the display module is usually a display built into the computing device, which is made with a separate input device, such as a keyboard, or with the “touch screen” technology.

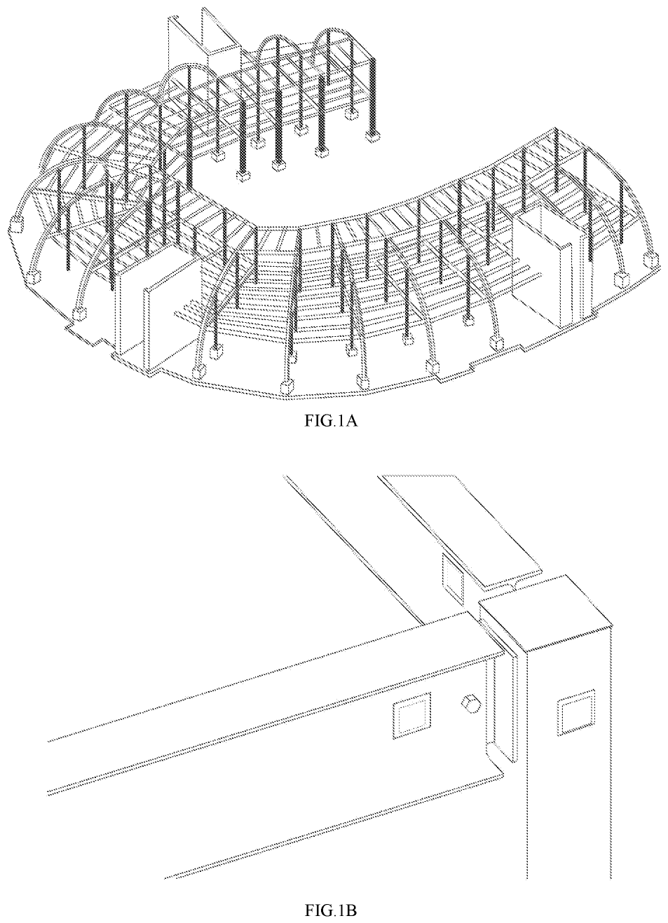

The remote server is designed to store a three-dimensional information model of a structure and associated data, store new transmitted data, as well as to provide access to them for users. Initially, the three-dimensional information model is recorded on the server (FIG. 1A), for example, in fbx format, and the associated data, for example, in j son format, containing information about the elements of the structure, coordinates of design places on them for markers, which may be viewed on the model (FIG. 1B), as well as identification codes of the elements that allows one to derive information about the elements.

The information about the elements, such as structural beams, includes their names and may additionally include at least one of the following: information about element types, element sizes, element weights, names of neighboring elements with which a current element is in connection, their size, weight, and other things that may be entered during the design phase of the three-dimensional model using the BIM technology. The data on the coordinates of the design places on the elements for the application of the markers are related to the information on the dimensions of future markers, which is used to increase the accuracy of measuring the distance to them; however, distance measurement is possible without the information on the dimensions.

The markers may be applied at any stage, such as the production of the elements, their storage, transportation, or assembly/construction. The markers are predominantly graphic images, usually black and white, of simple shape in the form of a rectangle or a square with an identifier-image inscribed inside, but other images may also be used. The use of similar images in fiduciary markers is known from the prior art.

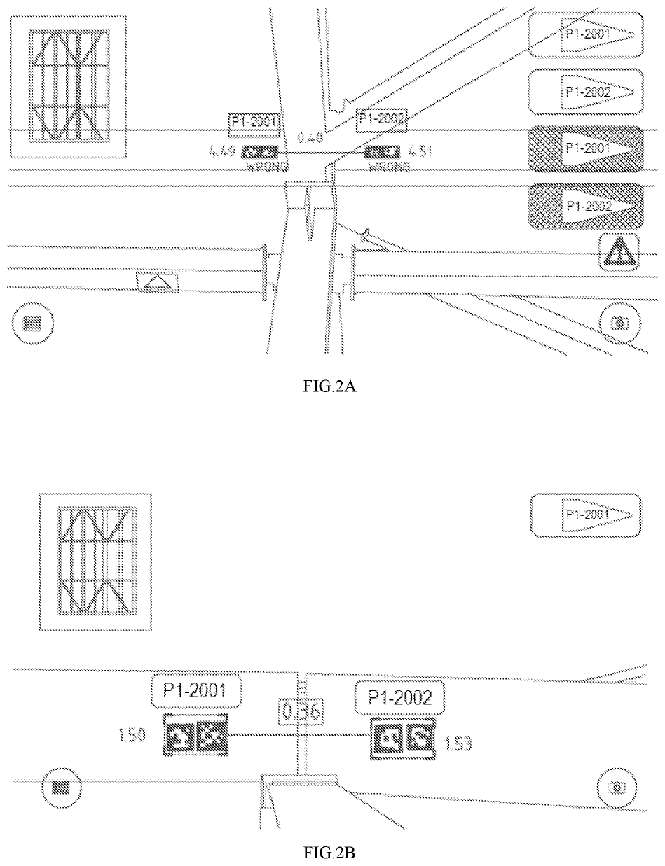

With the help of the computing device and the display module, actions are performed with the application of all capabilities of the mentioned device or only part of them, depending on the need for specific capabilities at the current stage of the construction or assembly process. For example, the stages may be storage, transportation, assembly or installation. In the meantime, different system capabilities may also be applied at each said stage, as will be apparent from the description of the system operation. It is essential that the system is in principle capable of performing all of the operations claimed in the independent claim. In this case, a particular user may, at this stage, apply only part of the capabilities, for example, used to associate the markers with the identification codes of the elements, and another user may, in another period of time, scan the applied markers on the connected elements of the structure and identify discrepancies with the design (FIGS. 2A-2B).

The computing device is configured to receive, i.e., download, the information model and the data from the remote server by means of the data exchange module and store them in the memory module. Any reception and -transmission of data by means of the data exchange module takes place in the presence of communication with the remote server.

Also, the computing device is able, when scanning the markers by means of the video camera, to carry out their recognition and calculate the distances to the recognized markers, including the determination of their angles, which makes it possible to correctly identify the position of the elements of the structure. Said scanning means the processes of pointing the video camera at a marker and processing a video stream in real-time. When recognizing the markers and calculating the distances to them, the prior art algorithms are used, which are often implemented with the aid of augmented reality.

The calculation of the distances to the markers and the determination of the mutual position between them are performed by using the characteristics of the video camera sensor. Data on the focal length and the location of the point in the frame, which indicates the offset of the depth axis of the frame, are used. The calculations use marker size data and the known size of the marker in the frame in pixels to improve accuracy. With the above techniques, which are input data, by calculating the radius distance from the video camera to the center of the marker and calculating the X and Y axis distances in the frame plane from the center of the frame to the center of the marker, three-dimensional coordinates of the center of the marker relative to the video camera are compiled, which are used to calculate the distance between the markers.

The system is used when the markers are applied to the elements of the structure, before or after any marker is directly attached to the element. For this purpose, the computing device is configured to download the information on the elements of the structure and their identification codes after receiving the data from the remote server, which involves identifying these data in one or more downloaded files and granting access to them for a user. Then, the identification codes of the elements are associated with the recognized markers before or after their application on the elements according to the coordinates of places, and a command is issued to the display module to display the downloaded information on the elements, the identification codes of which are associated with the markers. This is implemented by enabling the user to search for and select an element from the catalog, for example, according to its name, which is included in the concept of the information about the element, and by enabling the user to associate the selected element with the recognized marker which is already attached or will be attached. After that, the computing device stores the data on said association in the memory module and transmits them to the remote server via the data exchange module.

Adhesive stencils on which the markers are printed may be used to increase the accuracy of applying the markers to the elements, with dimensions corresponding to the dimensions of the elements. For example, a marker should be applied at a distance of 0.3 m from the edge of a construction beam. For this purpose, a stencil is made with a marker whose center is at a distance of 0.3 m from the edge of the stencil. The height of the stencil also corresponds to the height of the beam. Another option to increase the accuracy of applying the markers is also possible.

Once the markers are applied, the proposed system may be used to directly control the construction or assembly processes. At this stage, the remote server additionally contains data about said association of the markers with the identification codes of the elements.

After the data containing the information about the elements of the structure, the data on said association of the markers with the identification codes, and the coordinates of the design places on the elements for the markers are downloaded from the remote server by means of the data exchange module, the markers are scanned for their recognition and the distances to them are calculated. The computing device derives, from the data stored in the memory module, the information about the elements of the structure on which the markers are recognized, determines the mutual position between the recognized markers by calculating the distance to them, and compares it with the mutual position of the markers according to the coordinates of the design places on the elements.

After that, the computing device issues commands to the display module to display the downloaded information about the elements, for example, their names, the comparison results, for example, by color, where red or yellow—no match, green—corresponds to the design position (FIGS. 2A-2B), as well as to display the distances to the markers (FIGS. 2A-2B—the distance is shown in white numbers in meters next to the markers) and/or the distances between them (FIGS. 2A-2B—the distance is shown between the markers). Depending on the implementation of the system, the color, style and font of readings may vary. Also, only the distances to the markers, only the distances between the markers, or both distances may be displayed. The device then stores the recognized markers and the calculated distances to them, as well as the comparison results, in the memory module and transmits them to the remote server via the data exchange module. The data are used to control the processes of constructing and assembling the structure by a remote user.

Obviously, the above-listed basic capabilities of this system allow reducing the time of construction/assembly of structures due to the implemented principle of instant control of the conformity of the assembled structure to the design with the output of the results to a checker and the remote user.

The computing device may optionally perform the additional operations listed below. They extend the functionality of the system, but are not necessary to achieve the technical result.

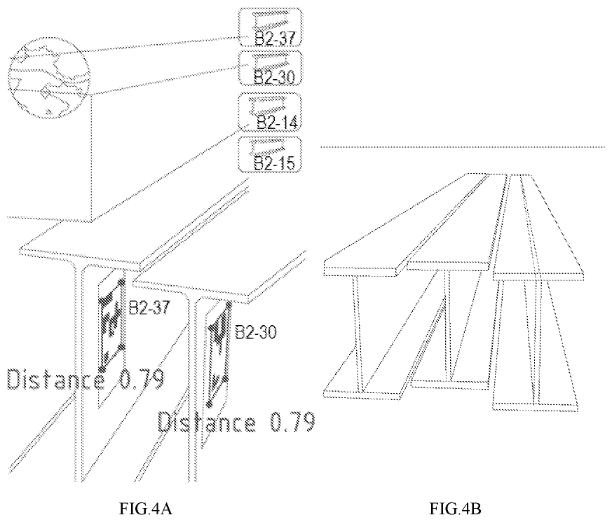

When scanning one or more of the markers on the elements of the structure and if the pre-downloaded data containing the information about the elements, the data about said association of the markers with the identification codes and the coordinates of the design places on the elements for the markers are available, the device is configured to download the information about the elements on which markers are recognized and create the three-dimensional model that reflects the current location of the elements of the structure on which the markers are recognized according to the calculated distances to them, issue a command to the display module to display the downloaded information about the elements and the created three-dimensional model (FIGS. 4A-4B), store it in the memory module, and transmit it to the remote server via the data exchange module. This embodiment is mainly used to monitor the elements of the structure during storage and/or transportation.

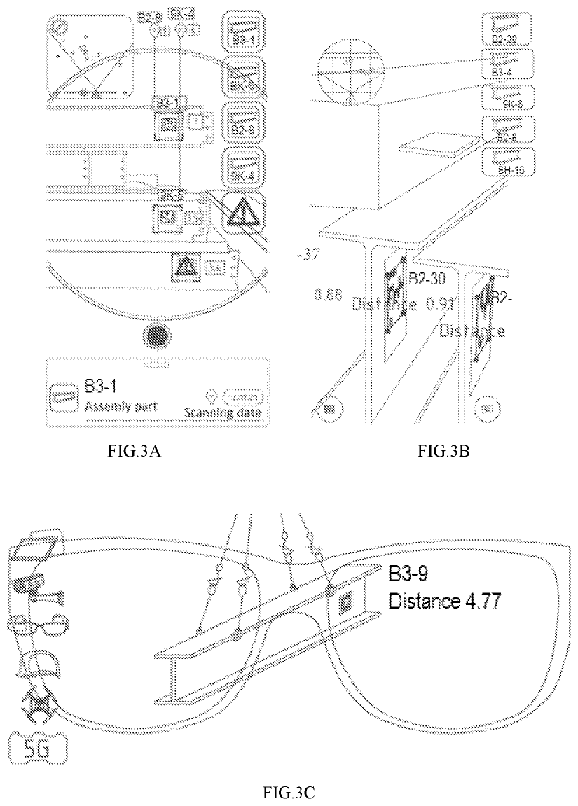

When scanning one or more of the markers and if the pre-downloaded data containing the information about the elements, the data about said association of the markers with the identification codes and the coordinates of the design places on the elements for the markers are available, the computing device may download the information about the elements of the structure on which the markers are recognized and calculate the distances to them, issue a command to the display module to display the distances to the markers and the downloaded information (FIGS. 3B, 3C), and store data about the recognition of one or more of the markers (FIGS. 3B, 3C). This embodiment is mainly used to monitor the elements of the structure during storage and/or transportation, view the information about the elements, which in addition to their names may contain data on weight, dimensions, and names of neighboring elements, with which the current element is connected, their size and weight, which will help to store, for example, construction beams which will be connected or provided next to each other, to determine the maximum load of a vehicle from weight information and many other things.

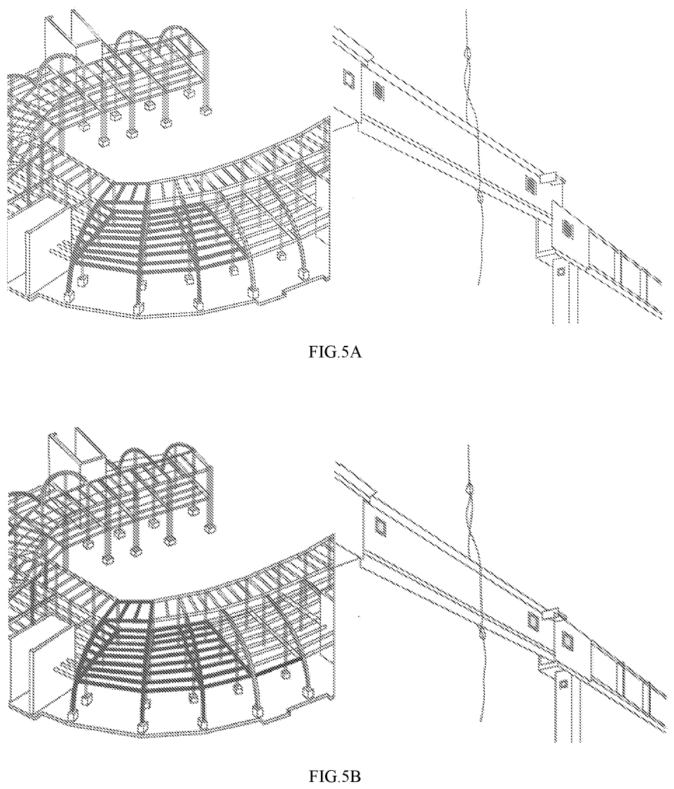

When scanning one or more of the markers and if the pre-downloaded three-dimensional information model of the structure and the data containing, among other things, the data about said association of the markers with the identification codes are available, the computing device may download the three-dimensional model and command the display module to display at least a portion of the three-dimensional model showing the elements on which one or more of the markers are recognized (FIGS. 1A, 5A, 5B). This embodiment may be used to view the model to identify neighboring elements, their design location, and others. In addition, visualization in this embodiment may be performed in augmented reality, i.e., the user, for example, in appropriate glasses scans the markers and at the same time sees the designed three-dimensional model of the structure, which is superimposed on the actually located elements. This embodiment is convenient at the stage of structure installation.

The claimed system may include a GPS module connected with the computing device which is additionally configured, when scanning one or more of the markers and if the pre-downloaded data containing, among other things, the data about said association of the markers with the identification codes, to calculate the distances to the recognized markers and assign GPS coordinates to them, store the corresponding data in the memory module, and transmit them to the remote server via the data exchange module. The GPS coordinates are assigned to the markers with correction for the distance to them from the device with the GPS module. This embodiment may be used to monitor the elements of the structure during storage and/or transportation, i.e., when their territorial position is checked. It is preferably combined with other embodiments, in particular, with the embodiment in which the distances to the recognized markers are calculated and displayed.

When the results of the recognition of the markers and the calculated distances to them after a first scan are stored in the memory module, the device may issue commands to the display module to display distances to locations of unrecognized or hidden markers if the markers are partly recognized on a next scan (FIG. 3A—blue location indicators in the upper part). This feature will speed up the search for necessary elements.

The proposed system operates as follows.

Using the BIM technology, the three-dimensional information model of the structure, such as a building frame, is developed. Each element, for example, each structural beam, is assigned an identification code, by which it is possible to identify information about the corresponding element—its name and in some cases may be at least one of the following: type, size, weight, names of neighboring elements, with which the current element is connected, their size and weight. The information model and the data comprising said information, the identification codes, and the coordinates of places for the markers are stored on the remote server.

For example, at the manufacturing stage of the elements of the structure, a graphic marker is applied to each beam by gluing or otherwise according to the design coordinates which are pre-downloaded as part of the data by the computing device and viewed by the user. To increase the accuracy of applying the markers, the markers may be produced on a stencil whose dimensions, when applied to the edge of the design element, allow the marker to be accurately applied. The markers may also be applied at the stage of assembly/assembly of the structure.

Before or after the markers are applied, the markers are recognized by means of scanning, and each marker is associated with the corresponding element identification code. Said association is performed by selecting the element according to the information displayed by the display module about the elements of the structure, for example, by searching by a beam name. The association data are stored and sent to the remote server if communication is available.

Further, at the stage of the structure installation, a worker performs the recognition of the markers by means of scanning, for example, with the video camera of a smartphone. From the downloaded data containing the information about said association of the markers, the information about the corresponding elements on which the markers are recognized is automatically derived. The distances to the markers in the field of view of the video camera, their angular positions are calculated. The mutual position between the markers is determined, compared with the mutual position of the markers according to the coordinates of the design places and displayed on the display, for example, of a smartphone, as the information about the elements—the name, for example, “B3-1” (FIGS. 2A-2B, 3A-3B, 4A), and the results of comparison with the position of the markers in the information model, for example, by highlighting correctly installed beams in green, and red—wrong (FIGS. 2A-2B), since the distance between the markers does not match the distance according to the design, taking into account an allowable deviation. The distances to the markers and/or the distances between them are also displayed, depending on the system implementation.

The data about the results of the recognition of the markers and the comparison results are then stored in the memory module and transmitted to the remote server via the data exchange module.

Additionally, the worker may observe the assembly process and, when scanning and recognizing the markers, view at least parts of the three-dimensional model of the structure showing the elements on which one or more of the markers are recognized, i.e., the designed three-dimensional model (FIGS. 1A, 5A-5B). For this purpose, when a marker is recognized on a design element and information about it is displayed, the user marks the element as an anchor element. After that, at least a part of the designed model of the structure is displayed on a display, for example, a smartphone. Alternatively, the designed model may be displayed in a real-time augmented reality mode.

The advantage of the proposed solution is the possibility for a checker to use, at any moment, the information model and all the data and results of recognition with distance calculation stored on the remote server, and to see the stage of construction or assembly of the structure, the degree of completion, detected violations and deviations from the design in the process of assembly, the position of elements, as well as the territorial location of the elements of the structure on the map when using the possibility of associating with GPS coordinates.

Thus, the use of the system according to the present invention will allow recognizing errors in the assembly of structures at an early stage and promptly making a decision on the method of elimination, including through remote monitoring, to track the processes of storage and transportation, to place the elements depending on the order of assembly of the structure, to minimize the risks of incorrect assembly due to the output of information when recognizing the markers in real-time, which significantly reduces the construction time.

1. A system for controlling construction processes, comprising:
a remote server; and
at least one computing device connected with one or more video cameras for scanning markers, a memory module, a data exchange module for communication with the remote server, and a display module, wherein
the remote server is configured to store a three-dimensional information model of a structure and data containing information about elements of the structure, coordinates of design places on the elements of the structure for applying the markers and identification codes of the elements for deriving the information about the elements of the structure, and also configured to store transmitted data,
the at least one computing device is configured to receive, from the remote server, the information model and the data through the data exchange module and store the information model and the data in the memory module, while scanning the markers to recognize the markers and calculating distances to the recognized markers, wherein the at least one computing device is further configured to:
download the information about the elements of the structure and the identification codes of the elements after receiving the data from the remote server, associate the identification codes of the elements with the recognized markers before or after the markers are applied to the elements in accordance with the coordinates of the design places, issue a command to the display module to display the downloaded information about the elements whose identification codes are associated with the markers, store data about said association in the memory module and transmit the data about said association to the remote server via the data exchange module,
when scanning the markers, if the data about said association of the markers with the identification codes and the data from the remote server are available, download the information about the elements of the structure, on which the markers are recognized, and the coordinates of the design places for the markers on the elements, determine and compare a mutual position between the recognized markers with a mutual position of the markers according to the coordinates of the design places, issue a command to the display module to display the downloaded information, compare results, as well as the distances to the markers and/or distances between the markers, store the data about the recognized markers and the distances to the markers, as well as about the results of said comparison in the memory module and transmit the data to the remote server through the data exchange module.

2. The system according to claim 1, wherein the at least one computing device is further configured, when scanning one or more of the markers and if the data about said association of the markers with the identification codes and the data from the remote server are available, to download the information about the elements of the structure on which the markers are recognized and create the three-dimensional model reflecting a current location of the elements of the structure with the recognized markers, issue a command to the display module to display the downloaded information about the elements and the created three-dimensional model, store the information about the elements and the created three-dimensional model in the memory module and transmit the information about the elements and the created three-dimensional model to the remote server via the data exchange module.

3. The system according to claim 1, wherein the at least one computing device is further configured, when scanning one or more of the markers and if the data about said association of the markers with the identification codes and the data from the remote server are available, to download the information about the elements of the structure on which the markers are recognized, issue a command to the display module to display the distances to the markers and the downloaded information, store the data about said recognition of one or more of the markers and the distances to the recognized markers in the memory module, and transmit the data to the remote server via the data exchange module.

4. The system of claim 1, wherein the at least one computing device is further configured, when scanning one or more of the markers and if the data about said association of the markers with the identification codes and said storage of the three-dimensional information model of the structure in the memory module are available, to issue a command to the display module to display at least a portion of the three-dimensional model of the structure that shows the elements on which one or more of the markers are recognized.

5. The system according to claim 1, wherein the at least one computing device is further configured, when scanning one or more of the markers and if the data about said association of the markers with the identification codes and said storage of the three-dimensional information model of the structure in the memory module are available, to issue a command to the display module to display at least a portion of the three-dimensional model of the structure that shows the elements on which the markers are recognized in an augmented reality mode.

6. The system according to claim 1, further comprising a GPS module connected with the at least one computing device, and wherein the at least one computing device is further configured, when scanning one or more of the markers and if the data about said association of the markers with the identification codes are available, to calculate the distances to the recognized markers and assign GPS coordinates to the recognized markers, store corresponding data in the memory module and transmit the corresponding data to the remote server via the data exchange module.

7. The system according to claim 3, wherein the at least one computing device is further configured, if the results of said recognition of the markers and the calculated distances to the recognized markers after a first scan are stored in the memory module, to issue a command to the display module to display distances to locations of unrecognized or hidden markers when the markers are partly recognized on a next scan.

8. The system according to claim 1, wherein said one or more video cameras are provided in a smartphone, a tablet computer, a laptop, a surveillance system, virtual reality glasses, augmented reality glasses, on a worker's helmet, and/or on a quadcopter.
